(19) United States
(12) Patent Application Publication
(10) Pub. No.: US 2013/0346160 A1
(43) Pub. Date: Dec. 26, 2013

(54) Commerce System and Method of Using Consumer Feedback to Invoke Corrective Action

(71) Applicants: Robert J. Dunst, Sebastopol, CA (US); Jonathan G. Zakaras, Mesa, AZ (US)

(72) Inventors: Robert J. Dunst, Sebastopol, CA (US); Jonathan G. Zakaras, Mesa, AZ (US)

(73) Assignee: MYWORLD, INC., Scottsdale, AZ (US)

(21) Appl. No.: 13/533,857

(22) Filed: Jun. 26, 2012

(51) Int. Cl. G06Q 10/06

(52) U.S. Cl. 705/7.36

(57) ABSTRACT

A commerce system has a plurality of members including manufacturers, distributors, retailer, consumers, and feedback service provider. Feedback information is collected from a consumer associated with products and services. The feedback information can be collected with a wireless communication device. The consumer receives an incentive in the form of a discount or promotion to provide the feedback information. The feedback information is stored in a database. A feedback score is determined based on the feedback information. The feedback information is weighted based on consumer value. The feedback score and the feedback information are provided to a retailer. The feedback information can be presented on a website for comment by other consumers. The retailer implements corrective action based on the feedback score and the feedback information. The corrective action is reported back to the consumer. The commerce system is controlled using the feedback information and corrective action.

### FIELD OF THE INVENTION

The present invention relates in general to consumer purchasing and, more particularly, to a commerce system and method of using consumer feedback to invoke corrective action by retailer.

### BACKGROUND OF THE INVENTION

Business planning is commonly used in commercial ventures. In the retail environment, grocery stores, general merchandise stores, specialty shops, and other retail outlets face stiff competition for limited consumers and business. In the face of mounting competition and high expectations from investors, retailers must look for every advantage they can muster in maximizing market share, sales, revenue, and profit. The retailer operates under a business plan to set pricing, order inventory, formulate and run promotions, add and remove product lines, organize product shelving and displays, select signage, hire employees, expand stores, collect and maintain historical sales data, evaluate performance and trends, and make strategic decisions. The retailer can change the business plan as needed.

For example, the retailer may conduct a marketing campaign to attract consumers and increase sales. The marketing campaign may appear to have the desired effect in terms of higher sales for the discounted products, but retailers often miss an important statistic, i.e. the consumer's perception of the retailer in view of the present marketing incentives, as well as general observations of the retailer's overall business practices.

The retailer typically has multiple purposes for a marketing program. By lowering the price or providing discounts, the retailer foregoes short-term profit margin with the anticipation of increasing sales for one or more products. As a secondary effect, the retailer hopes to build consumer loyalty and market share. If the consumer patronizes the store for the sale items, he or she may also purchase other products at regular price. The more frequently a consumer enters the store, the more likely the retailer will become a preferred shopping choice for the consumer. If the consumer purchases only the sale items and uses another retailer for the bulk of his or her shopping needs, then the secondary effect of the marketing effort is not achieved.

A consumer-minded retailer should understand that while the consumer may state that price is important to the purchasing decision, there are other factors that influence consumer loyalty and selection of a preferred retailer. In addition to price, consumers choose a retailer based on service, convenience, product arrangement and availability, quality of product, hours of operation, length of lines at checkout, cleanliness of premises, safety, and overall perception of the shopping experience. Convenience is material factor. The consumer on the way home from work or picking up the children from school will likely stop at a store that is en route. To go out of the way for another store usually requires some reason or motivation, including the factors noted above.

Retailers try to understand specifically what makes consumers prefer one store over another. Retailers conduct consumer surveys, e.g. by phone or email. The surveys provide general information, but the sample size is usually narrow and often does not query the consumer at the optimal time, i.e. while on the premises of the retailer. Retailers hire professional observers, i.e. secret shoppers, to act as consumers and report back to the retailer on store operations from the consumer's point of view. The professional observers generally are too few in number to achieve a representative sample size and may not reflect the views of actual consumers. Retailers make consumer comment cards available at the checkout, but the shopper usually does not have time or motivation to complete the comment card so participation is low. In addition, consumers have a perception, probably with justification, that most comments are ignored or at least rarely acted upon by the retailer. Consumers sometimes post comments on general complaint websites. Nonetheless, retailers often do not change the business plan based on isolated consumer comments. Retailers remain in the dark about reasons and motivation for consumer loyalty. Consumers continue to search for retailers that conduct business according to the consumer's personal preferences.

In a highly competitive market, the profit margin is paper thin and consumer loyalty is at a premium. Retailers must understand and act upon consumer motivation and personal preferences for purchasing decisions. The retailers remain motivated to optimize the business plan and marketing strategy to maximize profit and revenue.

### SUMMARY OF THE INVENTION

A need exists to evaluate and respond to consumer feedback. Accordingly, in one embodiment, the present invention is a method of controlling a commerce system comprising the steps of collecting feedback information from a consumer associated with products and services, storing the feedback information in a database, determining a feedback score based on the feedback information, providing the feedback score and the feedback information to a retailer, implementing corrective action based on the feedback score and the feedback information, reporting the corrective action to the consumer, and controlling the commerce system using the feedback information and corrective action.

In another embodiment, the present invention is a method of controlling a commerce system comprising the steps of collecting feedback information from a first member of the commerce system, determining a feedback score based on the feedback information, providing the feedback score and feedback information to a second member of the commerce system, and implementing corrective action based on the feedback score and the feedback information.

In another embodiment, the present invention is a method of controlling a commerce system comprising the steps of collecting feedback information from a first member of the commerce system, evaluating the feedback information through a second member of the commerce system, providing the feedback information to a third member of the commerce system, and implementing corrective action based on the feedback information.

In another embodiment, the present invention is a computer program product usable with a programmable computer processor having a computer readable program code embodied in a tangible computer usable medium for controlling a commerce system comprising the steps of collecting feedback information from a first member of the commerce system, evaluating the feedback information through a second member of the commerce system, providing the feedback information to a third member of the commerce system, and implementing corrective action based on the feedback information.

### BRIEF DESCRIPTION OF THE DRAWINGS

FIG. 1 illustrates a retailer engaged in commercial activity with a consumer;

FIG. 2 illustrates a commercial system with a manufacturer, distributor, retailer, and consumer;

FIG. 3 illustrates commercial transactions between consumers and retailers with the aid of a feedback service provider;

FIG. 4 illustrates an electronic communication network between members of the commerce system;

FIG. 5 illustrates a computer system operating with the electronic communication network;

FIG. 6 illustrates a consumer profile registration webpage with the feedback service provider;

FIG. 7 illustrates a consumer login webpage for the feedback service provider;

FIG. 8 illustrates a consumer on the premises patronizing a retailer;

FIG. 9 illustrates a cell phone operating a mobile app for providing feedback to the feedback service provider;

FIG. 10 illustrates a cell phone operating a mobile app for providing feedback as a series of questions to the feedback service provider;

FIG. 11 illustrates a cell phone operating a mobile app for providing feedback as natural language responses to the feedback service provider;

FIG. 12 illustrates a webpage for providing feedback to the feedback service provider;

FIG. 13 illustrates a webpage for sharing consumer feedback with other consumers for additional comment;

FIG. 14 illustrates a webpage for scoring, grading, and ranking retailers based on consumer feedback;

FIG. 15 illustrates a feedback loop between the consumer, feedback service provider, and retailer;

FIG. 16 illustrates a webpage conveying corrective action to the consumer; and

FIG. 17 illustrates the process of controlling activities within the commerce system using consumer feedback and retailer correction action.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

In the face of mounting competition and high expectations from investors, most, if not all, a business must look for every advantage it can muster in maximizing market share and profits. The ability to consider factors which materially affect overall revenue and profitability and adjust the business plan accordingly is vital to the success of the bottom line, and the fundamental need to not only survive but to prosper and grow.

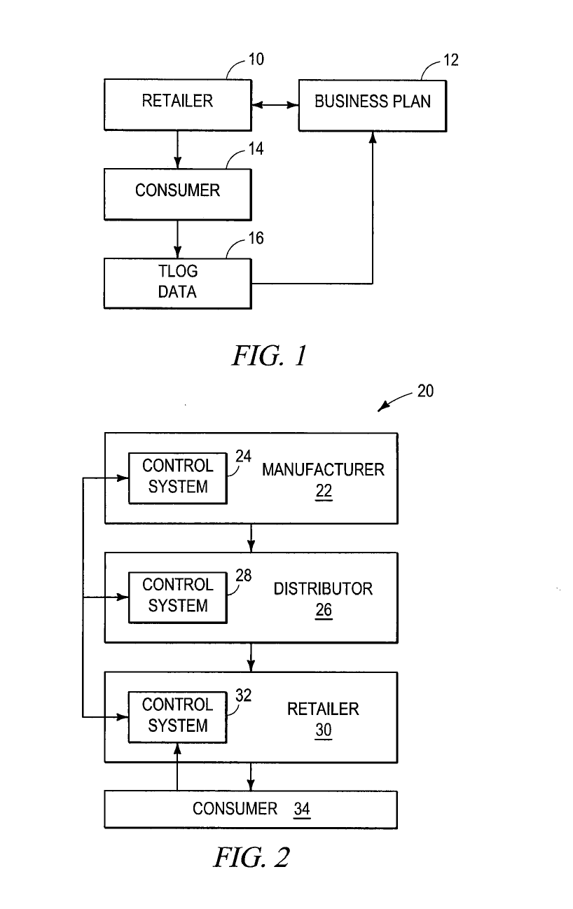

Referring to FIG. 1, retailer 10 has certain product lines or services available to consumers as part of its business plan 12. The terms products and services are interchangeable in the commercial system. Retailer 10 can be a food store, general consumer product retailer, drug store, discount warehouse, department store, apparel store, specialty store, or service provider. Retailer 10 operates under business plan 12 to set pricing, order inventory, formulate and run promotions, add and remove product lines, organize product shelving and displays, select signage, hire employees, expand stores, collect and maintain historical sales data, evaluate performance and trends, and make strategic decisions. Retailer 10 can change business plan 12 as needed. While the present discussion will involve a retailer, it is understood that the system described herein is applicable to data analysis for other members in the chain of commerce, or other industries and businesses having similar goals, constraints, and needs.

Retailer 10 routinely enters into sales transactions with customer or consumer 14. In fact, retailer 10 maintains and updates its business plan 12 to increase the number of transactions (and thus revenue and/or profit) between retailer 10 and consumer 14. Consumer 14 can be a specific individual, account, or business entity.

For each sale transaction entered into between retailer 10 and consumer 14, information is stored in transaction log (T-LOG) data 16. When a consumer goes through the checkout at a grocery store or any other retail store, each of the items to be purchased is scanned and data is collected and stored by a point-of-sale (POS) system, or other suitable data collection system, in T-LOG data 16. The data includes the then current price, promotion, and merchandizing information associated with the product along with the units purchased, and the dollar sales. The time, date, store, and consumer information corresponding to that purchase are also recorded.

T-LOG data 16 contains one or more line items for each retail transaction, such as those shown in Table 1. Each line item includes information or attributes relating to the transaction, such as store number, product number, time of transaction, transaction number, quantity, current price, profit, promotion number, and consumer identity or type number. The store number identifies a specific store; product number identifies a product; time of transaction includes date and time of day; quantity is the number of units of the product; current price (in US dollars) can be the regular price, reduced price, or higher price in some circumstances; profit is the difference between current price and cost of selling the item; promotion number identifies any promotion associated with the product, e.g., flyer, ad, discounted offer, sale price, coupon, rebate, end-cap, etc.; consumer identifies the consumer by type, class, region, demographics, or individual, e.g., discount card holder, government sponsored or under-privileged, volume purchaser, corporate entity, preferred consumer, or special member. T-LOG data 16 is accurate, observable, and granular product information based on actual retail transactions within the store. T-LOG data 16 represents the known and observable results from the consumer buying decision or process. T-LOG data 16 may contain thousands of transactions for retailer 10 per store per day, or millions of transactions per chain of stores per day.

TABLE 1
T-LOG Data

| STORE | PRODUCT | TIME | TRANS | QTY | PRICE | PROFIT | PROMOTION | CONSUMER |
|---|---|---|---|---|---|---|---|---|
| S1 | P1 | D1 | T1 | 1 | 1.50 | 0.20 | PROMO1 | C1 |
| S1 | P2 | D1 | T1 | 2 | 0.60 | 0.05 | PROMO2 | C1 |
| S1 | P3 | D1 | T1 | 3 | 3.00 | 0.40 | PROMO3 | C1 |
| S1 | P4 | D1 | T2 | 4 | 1.60 | 0.50 | 0 | C2 |
| S1 | P5 | D1 | T2 | 1 | 2.25 | 0.60 | 0 | C2 |
| S1 | P6 | D1 | T3 | 10 | 2.65 | 0.55 | PROMO4 | C3 |
| S1 | P1 | D2 | T4 | 5 | 1.50 | 0.20 | PROMO1 | C4 |
| S2 | P7 | D3 | T5 | 1 | 5.00 | 1.10 | PROMO5 | C5 |
| S2 | P1 | D3 | T6 | 2 | 1.50 | 0.20 | PROMO1 | C6 |
| S2 | P8 | D3 | T6 | 1 | 3.30 | 0.65 | 0 | C6 |

The first line item shows that on day/time D1, store S1 has transaction T1 in which consumer C1 purchases one product P1 at $1.50. The next two line items also refer to transaction T1 and day/time D1, in which consumer C1 also purchases two products P2 at $0.60 each and three products P3 at price $3.00 each. In transaction T2 on day/time D1, consumer C2 has four products P4 at price $1.60 each and one product P5 at price $2.25. In transaction T3 on day/time D1, consumer C3 has ten products P6 at $2.65 each in his or her basket. In transaction T4 on day/time D2 (different day and time) in store S1, consumer C4 purchases five products P1 at price $1.50 each. In store S2, transaction T5 with consumer C5 on day/time D3 (different day and time) involves one product P7 at price $5.00. In store S2, transaction T6 with consumer C6 on day/time D3 involves two products P1 at price $1.50 each and one product P8 at price $3.30.

Table 1 further shows that product P1 in transaction T1 has promotion PROMO1. PROMO1 can be any suitable product promotion such as a front-page featured item in a local advertising flyer. Product P2 in transaction T1 has promotion PROMO2 as an end-cap display in store S1. Product P3 in transaction T1 has promotion PROMO3 as a reduced sale price with a discounted offer. Product P4 in transaction T2 on day/time D1 has no promotional offering. Likewise, product P5 in transaction T2 has no promotional offering. Product P6 in transaction T3 on day/time D1 has promotion PROMO4 as a volume discount for 10 or more items. Product P7 in transaction T5 on day/time D3 has promotion PROMO5 as a $0.50 rebate. Product P8 in transaction T6 has no promotional offering. A promotion may also be classified as a combination of promotions, e.g., flyer with sale price, end-cap with rebate, or individualized discounted offer as described below.

Retailer 10 may also provide additional information to T-LOG data 16 such as promotional calendar and events, holidays, seasonality, store set-up, shelf location, end-cap displays, flyers, and advertisements. The information associated with a flyer distribution, e.g., publication medium, run dates, distribution, product location within flyer, and advertised prices, is stored within T-LOG data 16.

In FIG. 2, a commerce system 20 is shown involving the movement of goods between members of the system. Manufacturer 22 produces goods in commerce system 20. Manufacturer 22 uses control system 24 to receive orders, control manufacturing and inventory, and schedule deliveries. Distributor 26 receives goods from manufacturer 22 for distribution within commerce system 20. Distributor 26 uses control system 28 to receive orders, control inventory, and schedule deliveries. Retailer 30 receives goods from distributor 26 for sale within commerce system 20. Retailer 30 uses control system 32 to place orders, control inventory, and schedule deliveries with distributor 26. Retailer 30 sells goods to consumer 34. Consumer 34 patronizes retailer's establishment either in person or by using online ordering. The consumer purchases are entered into control system 32 of retailer 30 as T-LOG data 16.

The purchasing decisions made by consumer 34 drive the manufacturing, distribution, and retail portions of commerce system 20. More purchasing decisions made by consumer 34 for retailer 30 lead to more merchandise movement for all members of commerce system 20. Manufacturer 22, distributor 26, and retailer 30 utilize respective control systems 24, 28, and 32, to control and optimize the ordering, manufacturing, distribution, sale of the goods, and otherwise execute respective business plan 12 within commerce system 20 in accordance with the purchasing decisions made by consumer 34.

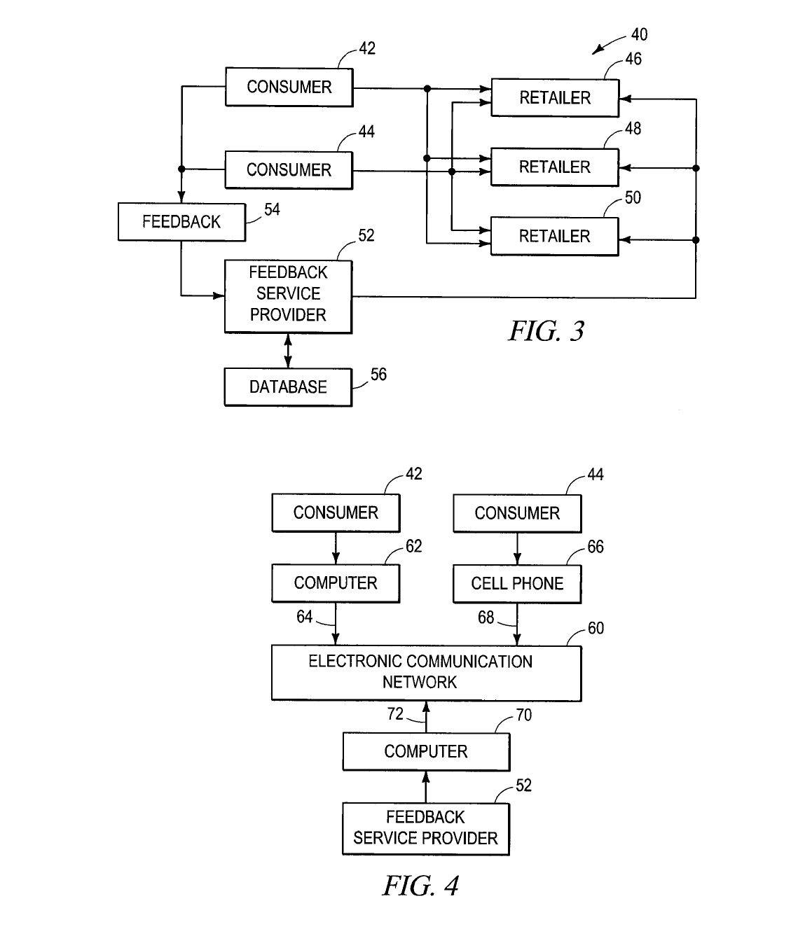

FIG. 3 illustrates a commerce system 40 with consumers 42 and 44 engaged in purchasing transactions with retailers 46, 48, and 50. Retailers 46-50 are supplied by manufacturers and distributors, as described in FIG. 2. Retailers 46-50 are typically local to consumers 42-44, i.e., retailers that the consumers will likely patronize. Retailers 46-50 can also be remote from consumers 42-44 with transactions handled by electronic communication medium, e.g., phone or online website via personal computer, and delivered electronically or by common carrier, depending on the nature of the goods. Consumers 42-44 patronize retailers 46-50 to select one or more items for purchase. For example, consumer 42 can visit the store of retailer 46 in person and select product P1 for purchase. Consumer 42 can contact retailer 48 by phone or email and select product P2 for purchase. Consumer 44 can browse the website of retailer 50 using a personal computer and select product P3 for purchase. Accordingly, consumers 42-44 and retailers 46-50 regularly engage in commercial transactions within commerce system 40.

As described herein, manufacturer 22, distributor 26, retailers 46-50, consumers 42-44, and feedback service provider 52 are considered members of commerce system 40. The retailer generally refers to the seller of the product and consumer generally refers to the buyer of the product. Depending on the transaction within commerce system 40, manufacturer 22 can be the seller and distributor 26 can be the buyer, or distributor 26 can be the seller and retailers 46-50 can be the buyer, or manufacturer 22 can be the seller and consumers 42-44 can be the buyer.

A feedback service provider 52 is a part of commerce system 40. Feedback service provider 52 is a third party that assists consumers 42-44 by collecting evaluations and feedback 54 from the consumer related to products and services of retailers 46-50. Feedback service provider 52 works with consumers 42-44 and retailers 46-50 to control commercial transactions within commerce system 40 by receiving feedback 54 from the consumers, evaluating the feedback, and providing the feedback to the retailers. Retailers 46-50 modify business plan 12 according to feedback 54. The modified business plan 12 increases sales to consumers 42-44, which increases commercial activity between manufacturer 22, distributor 26, and retailers 46-50.

More specifically, consumers 42-44 provide feedback 54 to feedback service provider 52 while patronizing retailers 46-50. Alternatively, consumers 42-44 can provide feedback 54 to service provider 52 using a computer and website after returning home. Feedback service provider 52 incentivizes consumers 42-44 to provide feedback 54. The incentives can be a discount or price reduction for one or more products. Consumers 42-44 will likely appreciate the discounts offered for providing feedback 54 as an additional value for participation with feedback service provider 52. Retailers 46-50 build market share and increase sales, revenue, and profit by enabling consumer service provider 52 to gather feedback 54. Feedback service provider 52 evaluates, scores, grades, and ranks retailers 46-50 based on feedback 54. Feedback service provider 52 makes feedback 54 available to retailers 46-50. Retailer 46-50 reviews feedback 54, takes correction action, and modifies business plan 12 accordingly. The response or corrective action of retailers 46-50 to feedback 54 is communicated to feedback service provider 52 and consumers 42-44. Consumers 42-44 will also appreciate the knowledge that retailer 46-50 took corrective action based on feedback 54.

FIG. 4 shows an electronic communication network 60 for transmitting information between consumers 42-44, feedback service provider 52, and retailers 46-50. Consumer 42 operating with computer 62 is connected to electronic communication network 60 by way of communication channel or link 64. Likewise, consumer 44 operating with a cellular telephone, smart phone, or other wireless communication device 66 is connected to electronic communication network 60 by way of communication channel or link 68. Feedback service provider 52 uses computer 70 to communicate with electronic communication network 60 over communication channel or link 72. The electronic communication network 60 is a distributed network of interconnected routers, gateways, switches, and servers, each with a unique internet protocol (IP) address to enable communication between individual computers, cellular telephones, electronic devices, or nodes within the network. In one embodiment, electronic communication network 60 is a cell phone service network. Alternatively, communication network 60 is a global, open-architecture network, commonly known as the Internet. Communication channels 64, 68, and 72 are bi-directional and transmit data between computers 62 and 70 and cell phone 66 and electronic communication network 60 in a hard-wired or wireless configuration. For example, computers 62 and 70 have email, texting, and Internet capability, and consumer cell phone 66 has email, texting, and wireless capability.

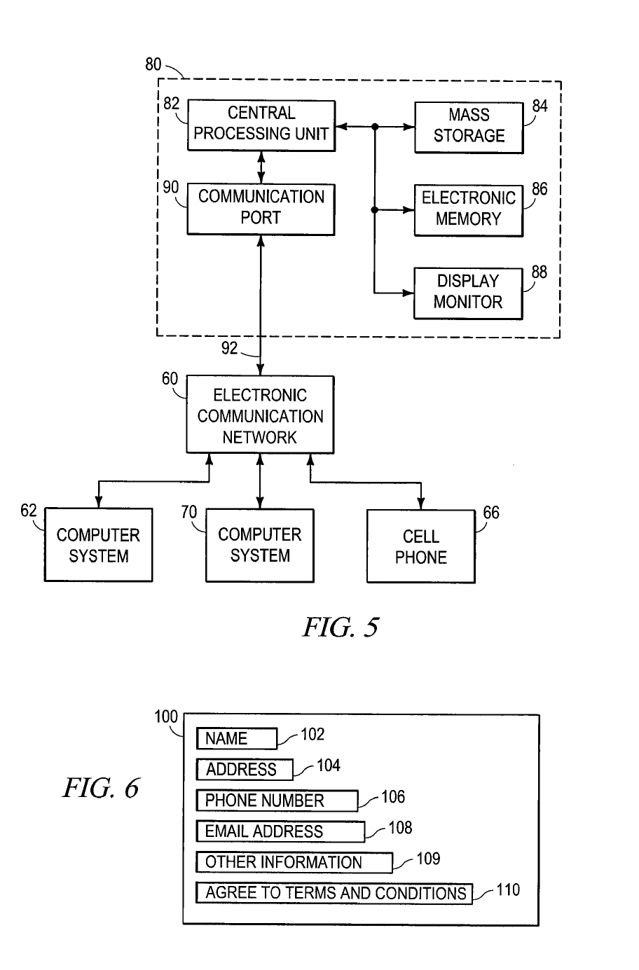

Further detail of the computer systems used in electronic communication network 60 is shown in FIG. 5 as a simplified computer system 80 for executing the software program used in the electronic communication process. Computer system 80 is a general purpose computer including a central processing unit or microprocessor 82, mass storage device or hard disk 84, electronic memory 86, display monitor 88, and communication port 90. Communication port 90 represents a modem, high-speed Ethernet link, wireless, or other electronic connection to transmit and receive input/output (I/O) data over communication link 92 to electronic communication network 60. Computer system or server 62 and 70 can be configured as shown for computer 80. Computer systems 62, 70, and 80 and cellular telephone 66 transmit and receive information and data over communication network 60.

Computer systems 62, 70, and 80 can be physically located in any location with access to a modem or communication link to network 60. For example, computer 62, 70, or 80 can be located in a home or business office. Feedback service provider 52 may use computer system 62, 70, or 80 in its business office. Alternatively, computer 62, 70, and 80 can be mobile and follow the user to any convenient location, e.g., remote offices, consumer locations, hotel rooms, residences, vehicles, public places, or other locales with electronic access to electronic communication network 60. The consumer can access feedback service provider 52 by mobile application operating in cell phone 66.

Each of the computers run application software and computer programs, which can be used to display user interface screens, execute the functionality, and provide the electronic communication features as described below. The application software includes an Internet browser, mobile application (app), local email application, word processor, spreadsheet, and the like. In one embodiment, the screens and functionality come from the application software, i.e., the electronic communication runs directly on computer system 62, 70, and 80. Alternatively, the screens and functions are provided remotely from one or more websites on servers within electronic communication network 60.

The software is originally provided on computer readable media, such as compact disks (CDs), external drive, or other mass storage medium. Alternatively, the software is downloaded from electronic links, such as the host or vendor website. The software is installed onto the computer system hard drive 84 and/or electronic memory 86, and is accessed and controlled by the computer operating system. Software updates are also electronically available on mass storage medium or downloadable from the host or vendor website. The software, as provided on the computer readable media or downloaded from electronic links, represents a computer program product containing computer readable program code embodied in a tangible computer program medium. Computers 62, 70, and 80 run application software for executing instructions for communication between consumers 42-44, retailers 46-50, and feedback service provider 52, to enable the consumer to convey feedback to the retailer to initiate corrective action. The application software is an integral part of the control of commercial activity within commerce system 40.

To interact with feedback service provider 52, consumers 42 and 44 first create an account and profile with the feedback service provider. Consumers 42 and 44 can use some features offered by feedback service provider 52 without creating an account, but full access requires completion of a registration process. The consumer accesses website 100 operated by feedback service provider 52 on computer system 70 and provides data to complete the registration and activation process, as shown in FIG. 6. The consumer can access website 100 using computer 62, 70, or 80 or cellular telephone 66 by typing the uniform resource locator (URL) for website 100, or by clicking on a banner located on another website which re-directs the consumer to a predetermined landing page for website 100. The data provided by the consumer to feedback service provider 52 may include name in block 102, address with zip code in block 104, phone number in block 106, email address in block 108, and other information and credentials, e.g. gender, age, and occupation, in block 109 necessary to establish a profile and identity for the consumer. The consumer's address and zip code are important as shopping is often a local activity. The consumer agrees to the terms and conditions of conducting electronic communication through feedback service provider 52 in block 110.

The profile can also contain information related to the shopping habits and preferences of consumers 42-44. Consumers 42-44 can specify preferred retailers and spending patterns. Alternatively, retailers 46-50 can provide T-LOG data 16 to feedback service provider 52 to accurate track the shopping patterns of consumers 42-44. Feedback surface provider 52 will have records of consumer loyalty and value to each retailer. Consumer value is based on spending patterns of the consumer.

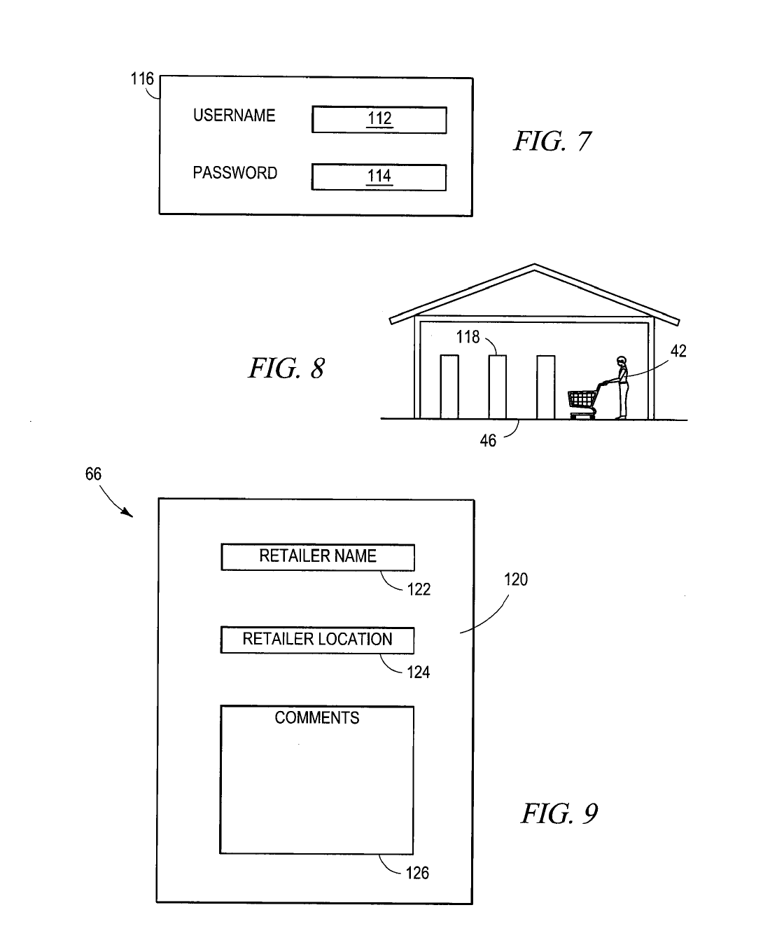

The consumer's profile is stored and maintained within database 56. The consumer can access and update his or her profile or interact by entering login name 112 and password 114 in webpage 116, as shown in FIG. 7. The consumer name can be any personal name, user name, number, or email address that uniquely identifies the consumer and the password can be assigned to or selected by the consumer. Accordingly, the consumer's profile and personal data remains secure and confidential within database 56 by feedback service provider 52.

Feedback service provider 52 wants to encourage consumers 42-44 to provide feedback 54 associated with shopping events. Feedback service provider 52 makes mobile apps available to consumer 42 to execute on cell phone 66. The cell phone app provides convenient and efficient communication between consumers 42-44 and feedback service provider 52. Alternatively, consumers 42-44 can communicate with feedback service provider 52 through computer 62, 70, or 80 and website.

FIG. 8 shows consumer 42 patronizing retailer 46. Consumer 42 selects one or more products for purchase from shelves 118 located within retailer 46. Consumer 42 makes a variety of observations while shopping with retailer 46. Consumer 42 may notice no product available for a promotional item or other needed product. Consumer 42 may not be able to find a product and give up, or ask an employee for the product location and receive incorrect directions. Consumer 42 may be disappointed by poor quality or freshness of the product. Consumer 42 may observe that the dairy case needs cleaning. Consumer 42 may come upon unreasonably long lines at checkout. Consumer 42 may experience safety concerns in the parking lot due to a lack of lighting or questionable people loitering. On the other hand, consumer 42 may receive polite and helpful service or free samples at the deli counter. An employee may retrieve replenishment stock from the storeroom for consumer 42 when the shelf is empty. Consumer 42 may identify a needed item, not on the shopping list, due to the convenient product arrangement on shelves 118. An employee may accompany consumer 42 to his or her vehicle at night to help with loading and provide a safety factor. The observations and experiences of consumer 42 can be positive or negative while shopping with retailer 46.

Feedback service provider 52 enables a convenient communication link for consumer 42 to provide realtime feedback 54 during the time on the premises of retailer 46. For example, when consumer 42 cannot purchase a promotional item due to out-of-stock condition, the consumer can scan the shelf bar code with cell phone 66 and transmit the product identification and no product available message to feedback service provider 52. When consumer 42 observes the unclean dairy case, the consumer can take a picture with cell phone 66 and transmit the picture with corresponding message to feedback service provider 52. When consumer 42 is standing in the long line at checkout, the consumer can take a picture of the long line and transmit the picture with corresponding message of the unreasonable delay to feedback service provider 52 using cell phone 66.

In a similar manner, consumer 42 can transmit a message of good service and positive experience to feedback service provider 52 with cell phone 66. When the employee retrieves replenishment stock from the storeroom for consumer 42, the consumer can ask the employee's name and transmit a message of good service attributed to the identified employee to feedback service provider 52 with cell phone 66. In any case, feedback service provider 52 can readily ascertain the time and date, as well as the retailer and location if cell phone 66 has global positioning system (GPS) capability. Alternatively, consumer 42 can identify retailer 46 and location in the message.

Feedback service provider 52 can incentivize consumer 42 to provide feedback 54 with discounts and promotions for products sponsored by retailers 46-50. Retailers 46-50 find feedback 54 to contain particular useful information. Retailers 46-50 may provide funding so that feedback service provider 52 can offer discounts and promotions for feedback 54 from consumers 42-44. For each feedback event, consumers 42-44 receive a coupon or discount for one or more products. Consumers 42-44 can also be motivated to provide feedback 54 to feedback service provider 52 by social participation. If everyone participates and provides feedback 54, then the collective social community benefits by the expanded knowledge base associated with retailers 46-50.

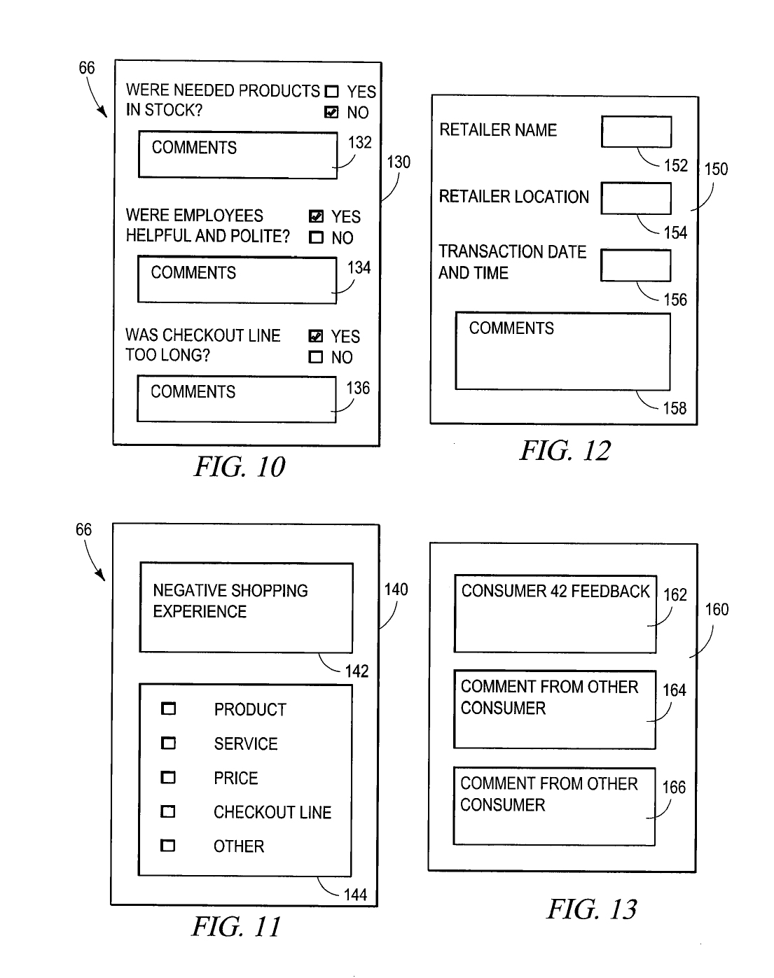

Consumer 42 chooses to provide feedback 54 to feedback service provider 52. Consumer 42 accesses cell phone 66 with mobile app 120, as shown in FIG. 9. In one embodiment, mobile app 120 allows consumer 42 to enter retailer name in block 122, retailer location in block 124, and general remarks or comments in block 126. In another embodiment, mobile app 130 allows consumer 42 to enter responses to a series of predefined questions, as shown in FIG. 10. The questions may include queries such as “were needed products on the shelf?”, with check boxes for yes or no. Block 132 allows for additional comments. The questions also include queries “were employees helpful and polite?” and “was checkout line too long?”, with respective check boxes for yes or no. Blocks 134 and 136 allow for additional comments. In the example of FIG. 10, consumer 42 provides feedback 54 that the needed product was not available on shelf 118, that an employee retrieved additional product from the storeroom for the consumer, and that the checkout line was too long. Instead of yes and no check boxes for the questions, a numerical range or sliding scale of responses can be presented to consumer 42. The sliding scale adjusts the level of agreement or disagreement with the posed question by moving a pointer along the length of the sliding scale. Alternatively, a specific value can be selected with a click operation via computer interface. The predetermined values can be 0 (strongly disagree) to 9 (strongly agree), “always”, “never”, or other designator meaningful to the consumer. The computer interface can be color coded or otherwise highlighted to assist with assigning an answer to the posed question.

Additional levels of queries can be hierarchically organized within mobile app 130. For example, the answer yes or a value, e.g. greater than 5, selected on the numeric range or sliding scale to the question whether the employee was helpful and polite prompts another set of more specific questions on cell phone 66 about the nature of the service or name of employee. Feedback service provider 52 can also generate multiple choice questions for consumer 42 to select the most appropriate answer.

In another embodiment, mobile app 140 allows consumer 42 to enter a natural language response in block 142, as shown in FIG. 11. The natural language response from block 142 is analyzed by feedback service provider 52 and prompts additional queries in block 144 based on the natural language response from consumer 42. For example, consumer 42 may provide a natural language response in block 142 that he or she just had a negative shopping experience in retailer 46. Feedback service provider 52 responds back in block 144 with a query whether the negative shopping experience was related to product, service, price, checkout line, or other reason. Consumer 42 responds by checking one or more boxes in block 144 next to the possible responses, or provides another natural language response in block 142, e.g. that a promotional item was out-of-stock after consumer 42 made a special trip to retailer 46 specifically to purchase the product. The natural language responses from block 142 is analyzed by feedback service provider 52 and prompts additional queries in block 144 based on the natural language response from consumer 42. The process continues as feedback service provider 52 gathers feedback 54 from consumer 42.

Consumer 42 can also provide feedback 54 by way of computer 62, 70, or 80 after returning home. Consumer 42 uses computer 62 to access website 150, as shown in FIG. 12. Website 150 allows consumer 42 to enter retailer name in block 152, retailer location in block 154, time and date in block 156, and general remarks or comments in block 158. In another embodiment, website 150 allows consumer 42 to enter responses to a series of predefined questions, similar to FIG. 10, or to enter natural language responses, similar to FIG. 11.

Feedback service provider 52 receives feedback 54 from consumer 42. Feedback 54 is combined with the profile for consumer 42 to yield a composite feedback record. Feedback 54 or the composite feedback record can be used for a variety of purposes. For example, the comments from consumer 42 can be posted in block 162 on a community website page 160 maintained by feedback service provider 52, as shown in FIG. 13. Other consumers can review the comments from consumer 42 and add similar or dissimilar experiences in blocks 164 and 166 as an open community forum. If consumer 42 is commenting about no product available for a promotional item, then other consumers can relay similar experiences of no product available. Alternatively, other consumers can state the experience that the promotional product was plentiful. Feedback service provider 52 can monitor the open community forum and moderate any inaccurate or inappropriate content.

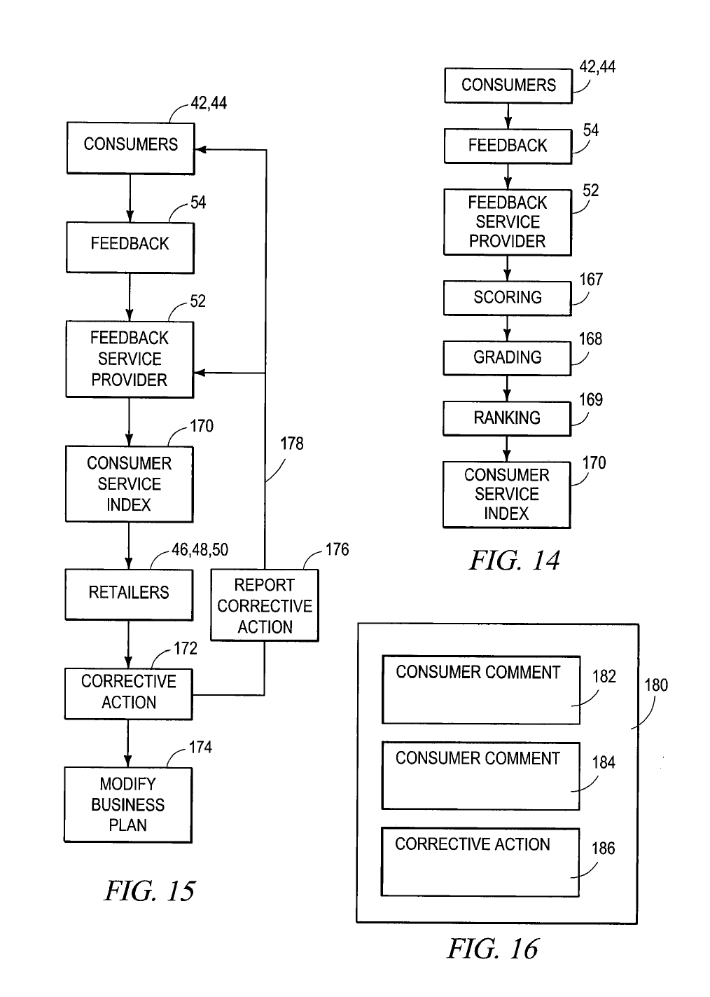

Feedback service provider 52 receives numerous records of feedback 54 from many different consumers, which are stored in database 56. Feedback service provider 52 can monitor feedback 54 and delete inaccurate or inappropriate content, with an explanation to the consumer. Feedback service provider 52 analyzes and organizes the feedback records for reporting to retailers 46-50, as shown in FIG. 14. For a given retailer, the feedback records can be scored in block 167 according to the content of the feedback. For example, feedback service provider 52 can score the number of negative comments for retailer 46 about no product available during a promotional period. Most feedback is negative so a lack of positive comments about product availability is not necessarily dispositive. However, an excessive number of negative comments for retailer 46 about no product available during a promotional period can be an indication of an ordering issue. An excessive number of negative comments for retailer 46 about long lines at checkout can be an indication of an employee scheduling issue. In one embodiment, the feedback scoring is the number of comments per retailer basis, such as volume of transactions. A retailer with higher volume of transactions is logically subject to a higher number of negative comments. Accordingly, the feedback score can be normalized to the volume of transactions. Other retailer basis include retailer location, time period, time of day, day of the week, consumer sample size, number of employees, marketing program, retail space, consumer traffic, retailer quality standards, and the like.

Feedback service provider 52 can determine a relative value of consumer comments based on the consumer profile. Comments from frequent or loyal consumers are weighted more heavily than comments from infrequent or first-time shoppers. The consumer value weighting is not intended to show favoritism, but a practical economic reality that retailer should pay particular attention comments from the best customers. Established and loyal customers are hard to replace.

Based on the scoring of feedback 54, feedback service provider 52 can determine a comparative feedback grade 168 for retailers 46-50. A retailer with fewer negative comments on a particular feedback topic or retailer basis receives a higher comparative feedback grade 168 than a retailer with more negative comments on the same feedback topic or retailer basis. The comparative feedback grading 168 can be based on one or more feedback topics or retailer basis, or a composite grade can be assigned across all feedback topics. Feedback service provider 52 uses the comparative feedback grading to determine a relative ranking of retailers 46-50 for one or more feedback topics or across all feedback topics. Feedback service provider 52 makes the feedback scoring, comparative feedback grading, and relative ranking available to retailers 46-50 as components of a consumer service index 170. Retailers 46-50 subscribe to consumer service index 170 or otherwise sponsor the activities of feedback service provider 52 to gain access to the feedback analysis, as well as the individual feedback records 54.

Retailers 46-50 pay particular attention to consumer service index 170 and individual feedback records 54. The consumer service index 170 and individual feedback records 54 are clear and credible indicators of the perception, personal preferences, and motivation of consumers 42-44 in selecting a retailer to patronize. Retailers 46-50 wanting to increase sales, revenue, profit, and market share should carefully consider consumer service index 170 and individual feedback records 54. For example, if retailer 46 realizes that multiple consumers are reporting the promotional products are not available for purchase, then the retailer should revise ordering procedures to make sure sufficient stock is on-hand to meet consumer demands. If retailer 48 understands that multiple consumers are reporting long lines at checkout, then the retailer should revise employee schedules to have enough registers open to minimize the consumer checkout time. If multiple consumers are reporting safety concerns with lighting in the parking lot, then additional lighting should be installed or security increased to relieve the consumer safety concerns. Retailers 46-50 update business plan 12 based on consumer service index 170 and individual feedback records 54 provided by feedback service provider 52 to address the concerns of consumers 42-44. Feedback service provider 52 becomes the voice of consumers 42-44. Feedback 54 from consumers 42-44 is reported to and, if appropriate, acted upon by retailers 46-50.

FIG. 15 shows the feedback loop between consumers 42-44, feedback service provider 52, and retailers 46-50. Consumers 42-44 provide feedback 54 to feedback service provider 52. Feedback service provider 52 analyzes and organizes feedback 54 and generates consumer service index 170 for retailers 46-50. Retailers 46-50 review consumer service index 170 and take corrective action 172. The corrective action 172 causes retailers 46-50 to modify business plan 12 in block 174. As a final step to close the feedback loop, feedback 54, consumer service index 170, and corrective action 172 taken by retailers 46-50 are reported back to feedback service provider 52 and consumers 42-44 in block 176. Feedback service provider 52 and consumers 42-44 are aware that corrective action 172 has been taken for feedback 54.

Retailers 46-50 can use a variety of communication channels 178 to make feedback service provider 52 and consumers 42-44 aware that feedback was received and duly considered. Retailers 46-50 can create a corrective action report that is transmitted to feedback service provider 52, which in turn relays the information to consumers 42-44. In another embodiment, retailers 46-50 may use a social network website 180 to post comments and corrective action, as shown in FIG. 16. Consumer comments are posted in blocks 182 and 184. Corrected action is posted in block 186. Consumers 42-44 can view social network website 180 to see how feedback 54 made a difference. Retailers 46-50 may not act upon all feedback 54. In some cases, consumer comments may be viewed as impractical or unnecessary. The fact that feedback 54 is at least heard and considered is often enough to satisfy consumers 42-44.

Based on correction action 172 taken by retailers 46-50, feedback service provider 52 can determine a comparative responsiveness grade for the retailers. A retailer that reviews and carefully considers consumer service index 170 and individual feedback records 54 and further takes corrective action 172 receives a higher comparative responsiveness grade than a retailer that fails to review and carefully consider the consumer service index and individual feedback records or otherwise fails to take corrective action. The comparative responsiveness grading can be based on one or more responsiveness topics, or a composite responsiveness grade can be assigned across all responsiveness topics. The comparative responsiveness grading provides a metric of the retailer's commitment to listen to consumers 42-44 and take appropriate correction action to maintain the consumer's business. Feedback service provider 52 uses the comparative responsiveness grading to determine a relative responsiveness ranking of retailers 46-50 for one or more responsiveness topics or across all responsiveness topics. Feedback service provider 52 makes the comparative responsiveness grading and relative responsiveness ranking available to retailers 46-50 as additional components of consumer service index 170. Retailers 46-50 subscribe to consumer service index 170 or otherwise sponsor the activities of feedback service provider 52 to gain access to the feedback and responsiveness analysis, as well as the individual feedback records 54.

The feedback and corrective action loop shown in FIG. 16 in part controls the movement of goods between members of commerce systems 20 and 40. Consumers 42-44 provide feedback 54 to feedback service provider 52. Feedback service provider 52 analyzes and organizes feedback 54 and generates consumer service index 170 for retailers 46-50. Retailers 46-50 review consumer service index 170 and take corrective action 172. The corrective action 172 causes retailers 46-50 to modify business plan 12 in block 174. The correction action 172 confirms or builds consumer loyalty. Consumers 42-44 continue to purchase products from retailers 46-50, which affects the flow of goods between the members of commerce systems 20 and 40.

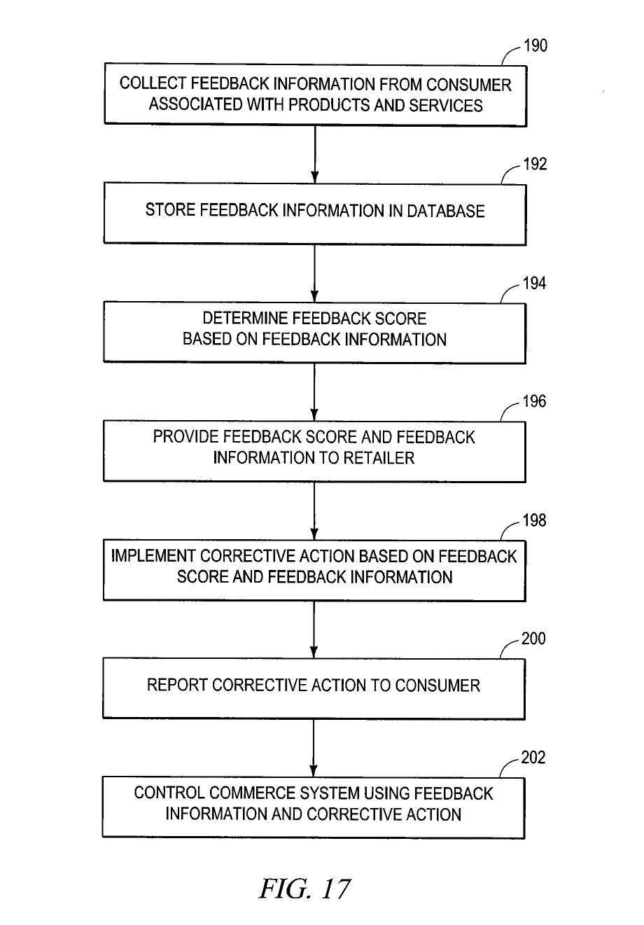

FIG. 17 illustrates a process for controlling a commerce system by enabling the consumer to convey feedback to the retailer to initiate corrective action. In step 190, feedback information is collected from a consumer associated with products and services. The feedback information can be collected with a wireless communication device. The consumer is incentivized with discounts and promotions for products to provide the feedback information. In step 192, the feedback information is stored in a database. The feedback information is made available on a website for comment by other consumers. In step 194, a feedback score is determined based on the feedback information. The feedback information is weighted based on consumer value. In step 196, the feedback score and the feedback information is provided to a retailer. In step 198, corrective action is implemented based on the feedback score and the feedback information. In step 200, the corrective action is reported back to the consumer. In step 202, the commerce system is controlled using the feedback information and corrective action.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of controlling a commerce system, comprising:
collecting feedback information from a consumer associated with products and services;
storing the feedback information in a database;
determining a feedback score based on the feedback information;
providing the feedback score and the feedback information to a retailer;
implementing corrective action based on the feedback score and the feedback information;
reporting the corrective action to the consumer; and
controlling the commerce system using the feedback information and corrective action.

2. The method of claim 1, further including providing an incentive for the consumer to provide the feedback information.

3. The method of claim 1, further including collecting the feedback information with a wireless communication device.

4. The method of claim 1, further including presenting the feedback information on a website for comment by other consumers.

5. The method of claim 1, further including weighting the feedback information based on consumer value.

6. A method of controlling a commerce system, comprising:
collecting feedback information from a first member of the commerce system;
determining a feedback score based on the feedback information;
providing the feedback score and feedback information to a second member of the commerce system; and
implementing corrective action based on the feedback score and the feedback information.

7. The method of claim 6, further including controlling the commerce system using the feedback information and corrective action.

8. The method of claim 6, further including reporting the corrective action to the first member of the commerce system.

9. The method of claim 6, further including providing an incentive for the consumer to provide the feedback information.

10. The method of claim 6, further including collecting the feedback information with a wireless communication device.

11. The method of claim 6, further including presenting the feedback information on a website for comment by other consumers.

12. The method of claim 6, wherein the first member of the commerce system includes a consumer and the second member of the commerce system includes a retailer.

13. The method of claim 12, further including weighting the feedback information based on consumer value.

14. A method of controlling a commerce system, comprising:
collecting feedback information from a first member of the commerce system;
evaluating the feedback information through a second member of the commerce system;
providing the feedback information to a third member of the commerce system; and
implementing corrective action based on the feedback information.

15. The method of claim 14, further including determining a feedback score based on the feedback information.

16. The method of claim 14, further including controlling the commerce system using the feedback information and corrective action.

17. The method of claim 14, further including reporting the corrective action to the first member of the commerce system.

18. The method of claim 14, further including providing an incentive for the consumer to provide the feedback information.

19. The method of claim 14, further including collecting the feedback information with a wireless communication device.

20. The method of claim 14, wherein the first member of the commerce system includes a consumer and the third member of the commerce system includes a retailer.

21. A computer program product usable with a programmable computer processor having a computer readable program code embodied in a tangible computer usable medium for controlling a commerce system, comprising:
collecting feedback information from a first member of the commerce system;
evaluating the feedback information through a second member of the commerce system;
providing the feedback information to a third member of the commerce system; and
implementing corrective action based on the feedback information.

22. The computer program product of claim 21, further including determining a feedback score based on the feedback information.

23. The computer program product of claim 21, further including reporting the corrective action to the first member of the commerce system.

24. The computer program product of claim 21, further including providing an incentive for the consumer to provide the feedback information.

25. The computer program product of claim 21, further including collecting the feedback information with a wireless communication device.
